(19) United States
(12) Patent Application Publication
(10) Pub. No.: US 2013/0163901 A1
(43) Pub. Date: Jun. 27, 2013

(54) HYDRODYNAMIC BEARING ASSEMBLY AND MOTOR INCLUDING THE SAME

(71) Applicant: Samsung Electro-Mechanics Co., Ltd, Suwon (KR)

(72) Inventor: Jin San KIM, Suwon (KR)

(73) Assignee: SAMSUNG ELECTRO-MECHANICS CO., LTD., Suwon (KR)

(21) Appl. No.: 13/713,156

(22) Filed: Dec. 13, 2012

(30) Foreign Application Priority Data
Dec. 26, 2011 (KR) 10-2011-0142692

(51) Int. Cl. F16C 32/06; H02K 7/08

(52) U.S. Cl. CPC F16C 32/0633; H02K 7/08
USPC 384/112; 384/107; 310/90

(57) ABSTRACT

There are provided a hydrodynamic bearing assembly and a motor including the same. The hydrodynamic bearing assembly includes: a shaft; and a sleeve having the shaft rotatably provided therein, having a bearing clearance formed between the shaft and the sleeve and filled with oil, and including a communication hole allowing the bearing clearance to be in communication with the outside, wherein the communication hole is sealed by a gas-liquid separating unit allowing gas to pass therethrough and blocking liquid.

### CROSS-REFERENCE TO RELATED APPLICATIONS

This application claims the priority of Korean Patent Application No. 10-2011-0142692 filed on Dec. 26, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same.

2. Description of the Related Art

A hard disk drive (HDD), an information storage device, reads data stored on a disk or writes data to the disk using a read/write head.

A hard disk drive requires a disk driving device capable of driving the disk. In the disk driving device, a small-sized motor is used.

In the small-sized motor, a hydrodynamic bearing assembly has been commonly used. A shaft and a sleeve of the hydrodynamic bearing assembly may be separated from each other by a predetermined interval to form a bearing clearance. A lubricating fluid such as oil may be interposed in the bearing clearance, such that a rotating member may be supported by fluid pressure generated in the oil.

Meanwhile, a structure in which the sleeve is provided with a communication hole allowing the bearing clearance to be in communication with the outside has been suggested. However, in this structure, there is a problem that the oil may be leaked through the communication hole.

### RELATED ART DOCUMENT

### (Patent Document 1) Japanese Patent Laid-Open Publication No. 2006-353058

### SUMMARY OF THE INVENTION

An aspect of the present invention provides a motor capable of preventing the leakage of a fluid in spite of using a hydrodynamic bearing structure including a communication hole.

According to an aspect of the present invention, there is provided a hydrodynamic bearing assembly including: a shaft; and a sleeve having the shaft rotatably provided therein, having a bearing clearance formed between the shaft and the sleeve and filled with oil, and including a communication hole allowing the bearing clearance to be in communication with the outside, wherein the communication hole is sealed by a gas-liquid separating unit allowing gas to pass therethrough and blocking liquid.

According to another aspect of the present invention, there is provided a hydrodynamic bearing assembly including: a shaft fixedly installed directly or indirectly on a base member; and a sleeve rotatably installed on the shaft, having a bearing clearance formed between the shaft and the sleeve and filled with oil, and including a communication hole allowing the bearing clearance to be in communication with the outside, wherein the communication hole is sealed by a gas-liquid separating unit allowing gas to pass therethrough and blocking liquid.

The gas-liquid separating unit may be formed of metal foam allowing gas to pass therethrough and blocking liquid.

The gas-liquid separating unit may be formed of a gas-liquid separating film allowing gas to pass therethrough and blocking liquid.

At least one of an inner peripheral surface of the sleeve and an outer peripheral surface of the shaft may be provided with a groove-shaped reservoir part so that the bearing clearance is wider in the reservoir part as compared with other portions thereof, and the communication hole may be in communication with the reservoir part.

The gas-liquid separating unit may be formed to have a ring shape so as to enclose an outer circumference of the sleeve in a circumferential direction.

The sleeve may include a seating groove formed in an outer peripheral surface thereof and having a ring shape corresponding to that of the gas-liquid separating unit to allow the gas-liquid separating unit to be seated thereon.

The gas-liquid separating unit may be inserted into the communication hole.

According to another aspect of the present invention, there is provided a spindle motor including: a hydrodynamic bearing assembly including a shaft, and a sleeve having the shaft provided therein, having a bearing clearance formed between the shaft and the sleeve and filled with oil, and including a communication hole allowing the bearing clearance to be in communication with the outside, the communication hole being sealed by a gas-liquid separating unit allowing gas to pass therethrough and blocking liquid; a stator coupled to the outside of the sleeve and a core having a coil wound therearound in order to generate rotational driving force; and a hub mounted to be rotatable with respect to the stator and having a magnet mounted on one surface thereof, the magnet facing the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a motor according to an embodiment of the present invention;

FIG. 2 is a schematic cross-sectional view illustrating a portion of a motor according to another embodiment of the present invention;

FIG. 3 is a schematic cross-sectional view illustrating a motor according to another embodiment of the present invention;

FIG. 4 is a schematic cross-sectional view illustrating a portion of a motor according to another embodiment of the present invention; and

FIGS. 5A and 5B are schematic cross-sectional views of a disk driving device using a motor according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

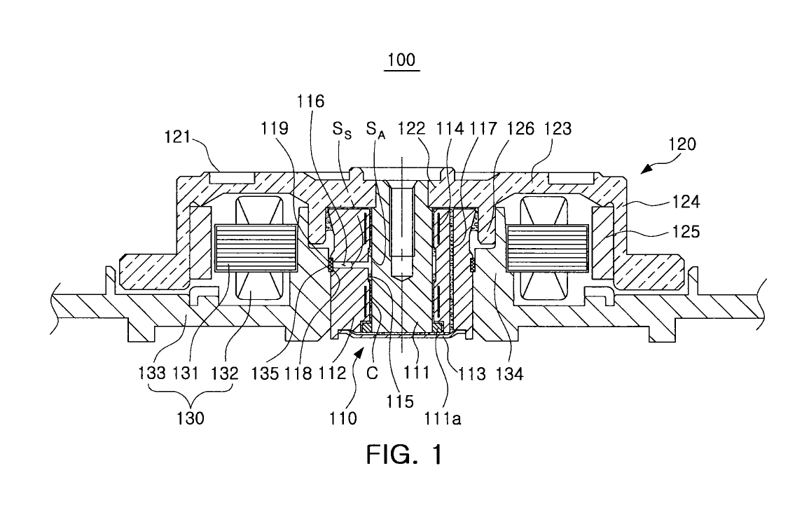

FIG. 1 is a schematic cross-sectional view illustrating a motor according to an embodiment of the present invention.

Referring to FIG. 1, a motor 100 according to the embodiment of the present invention may include a hydrodynamic bearing assembly 110 including a shaft 111 and a sleeve 112, a rotor 120 including a hub 121, and a stator 130 including a core 131 having a coil 132 wound therearound.

The hydrodynamic bearing assembly 110 may include the shaft 111, the sleeve 112, a stopper 111a, and the hub 121. Here, the hub 121 may be a component configuring the hydrodynamic bearing assembly 110 while simultaneously being a component configuring the rotor 120 to be described below.

Terms with respect to directions will first be defined. As viewed in FIG. 1, an axial direction refers to a vertical direction based on the shaft 111, and outer radial and inner radial directions refer to a direction toward an outer edge of the hub 121 based on the shaft 111 or a direction toward the center of the shaft 111 based on the outer edge of the hub 121.

Further, in the following description, rotating members may include the shaft 111, the rotor 120 including the hub 121, a magnet 125 mounted on the rotor 120, and the like, while fixed members, other than such rotating members, may be fixed, relative to the rotating members and include the sleeve 112, the stator 130, a base, and the like.

In addition, a communication path between an oil interface and the outside is connected to the outside of the motor and may have air introduced and discharged therethrough.

The sleeve 112 may support the shaft 111 while allowing an upper end of the shaft 111 to protrude upwardly in the axial direction. The sleeve 112 may be formed by sintering Cu—Fe-based alloy powders or SUS-based powders. However, the sleeve 112 is not limited to being manufactured by the above-mentioned method, but may be manufactured by various methods.

Here, the shaft 111 may be inserted into a shaft hole of the sleeve 112, having a micro clearance therebetween, to serve as a bearing clearance C. The bearing clearance may be filled with oil, and rotation of the rotor 120 may be smoothly supported by upper and lower radial dynamic pressure grooves 114 formed in at least one of an outer diameter of the shaft 111 and an inner diameter of the sleeve 112.

The radial dynamic pressure grooves 114 may be formed in the inner surface of the sleeve 112, an inner portion of the shaft hole of the sleeve 112, and generate pressure so that the shaft 111 may smoothly rotate in a state in which the shaft 111 is separated apart from the sleeve 112 by a predetermined interval at the time of rotation thereof.

However, the radial dynamic pressure grooves 114 are not limited to being formed in the inner surface of the sleeve 112 as described above, but may also be formed in an outer diameter portion of the shaft 111. In addition, the number of radial dynamic pressure grooves 114 is not limited.

The radial dynamic pressure grooves 114 may have at least one of a herringbone shape, a spiral shape, and a helical shape. However, the radial dynamic pressure groove 122 may have any shape as long as it can generate radial dynamic pressure.

The sleeve 112 may include a circulation hole 117 formed therein so as to allow upper and lower portions thereof to be in communication with each other to disperse pressure of the oil in the hydrodynamic bearing assembly 110, thereby maintaining balance in the pressure and moving air bubbles, or the like, present in the hydrodynamic bearing assembly 110 to be discharged by circulation.

Here, the sleeve 112 may include the stopper 111a provided on a lower end thereof, the stopper 111a protruding from the lower end portion of the shaft in the outer radial direction, wherein the stopper 111a may be caught by a lower end surface of the sleeve 112 to limit the floating of the shaft 111 and the rotor 120.

Meanwhile, the sleeve 112 may include a communication hole 116 allowing the bearing clearance C to be in communication with the outside. The sleeve 112 includes the communication hole 116 to enable a central portion of the bearing clearance C formed between the shaft 111 and the sleeve 112 to be in communication with the outside, whereby the air bubbles that may be generated in the oil provided in the bearing clearance C may be easily discharged.

Further, since the oil may be additionally provided in the communication hole 116, a total amount of oil provided in the bearing clearance C may be further secured.

Here, when the oil is provided in the communication hole 116, in the case in which the motor is not operated, an oil interface S_{S} may be additionally formed in the communication hole 116; however, in the case in which the motor is operated, the oil in the communication hole 116 is sucked into the bearing clearance C, such that oil interfaces S_{A} may be formed in upper and lower portions of the bearing clearance C between the shaft 111 and the sleeve 112, as shown in FIG. 1.

Meanwhile, according to the related art, there is a problem that the oil may be leaked through the communication hole. Therefore, according to the embodiment of the present invention, the communication hole 116 may be sealed by a gas-liquid separating unit 119 allowing gas to pass therethrough and blocking liquid, so that the air bubbles may be easily discharged, but the oil may not be leaked.

Here, the gas-liquid separating unit 119 may be formed of metal foam allowing gas to pass therethrough and blocking liquid. The metal foam may be a porous metal having a large number of air bubbles suspended in a foamed metal.

Further, the gas-liquid separating unit 119 may be formed of a gas-liquid separating film allowing gas to pass therethrough and blocking liquid. The gas-liquid separating film, having porosity, may be formed of various materials such as porous polytetrafluoroethylene, or the like.

Meanwhile, at least one of an inner peripheral surface of the sleeve 112 and an outer peripheral surface of the shaft 111 may be provided with a groove-shaped reservoir part 115 so that the bearing clearance C is wider in the reservoir part as compared with other portions thereof, and the communication hole 116 may be in communication with the reservoir part 115.

In addition, the gas-liquid separating unit 119 may be formed to have a ring shape so as to enclose an outer circumference of the sleeve 112 in a circumferential direction, and the sleeve 112 may include a seating groove 118 formed in an outer peripheral surface thereof and having a ring shape corresponding to that of the gas-liquid separating unit 119 to allow the gas-liquid separating unit 119 to be seated thereon.

Further, the sleeve 112 may be fixedly fitted into an inner portion of a protrusion flange 134 protruding upwardly from a base member 133, wherein the protrusion flange 134 may have a step part 135 formed in an inner portion thereof in order to secure a space between the protrusion flange 134 and the sleeve 112 so that the communication hole 116 is in communication with the outside.

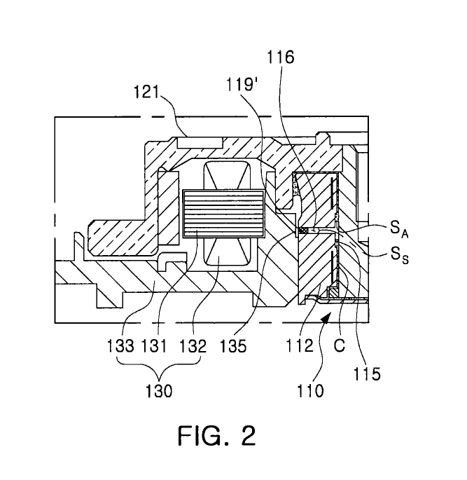

Meanwhile, with regard to the gas-liquid separating unit in the motor according to the embodiment of the present invention, a gas-liquid separating unit 119′ (See FIG. 2) may be provided to be fixed in a state in which it is inserted into the communication hole 116.

Meanwhile, the sleeve 112 may include a base cover 113 coupled thereto at a lower portion thereof in the axial direction, having a clearance therebetween, and the clearance receives oil therein.

The base cover 113 may receive the oil in the clearance between the base cover 113 and the sleeve 112 to serve as a bearing supporting a lower surface of the shaft 111.

The hub 121, a rotating member coupled to the shaft 111 and rotating together with the shaft 111, may configure the rotor 120 while simultaneously configuring the hydrodynamic bearing assembly 110. Hereinafter, the rotor 120 will be described in detail.

The rotor 120 may be a rotating structure provided to be rotatable with respect to the stator 130 and include the rotor hub 121 having the annular ring-shaped magnet 125 disposed on an inner peripheral surface thereof, wherein the annular ring-shaped magnet 125 corresponds to the core 131 to be described below, having a predetermined interval therebetween.

In other words, the hub 121 may be a rotating member coupled to the shaft 111 to rotate together with the shaft 111.

Here, as the magnet 125, a permanent magnet generating magnetic force having a predetermined strength by alternately magnetizing an N pole and an S pole thereof in a circumferential direction may be used.

In addition, the hub 121 may include a first cylindrical wall part 122 fixed to an upper end of the shaft 111, a disk part 123 extended from an end portion of the first cylindrical wall part 122 in the outer radial direction, and a second cylindrical wall part 124 protruding downwardly from an end portion of the disk part 123 in the outer radial direction, and the second cylindrical wall part 124 may include the magnet 125 coupled to an inner peripheral surface thereof.

The hub 121 may have a main wall part 126 extended downwardly in the axial direction so as to correspond to an outer portion of the upper portion of the sleeve 112.

In addition, an inner peripheral surface of the main wall part 126 may be tapered, such that an interval between the inner peripheral surface of the main wall part 126 and the outer surface of the sleeve 112 becomes wider downwardly in the axial direction to facilitate the sealing of the oil. Further, the outer surface of the sleeve 112 may also be tapered to facilitate the sealing of the oil.

The stator 130 may include the coil 132, the core 131, and the base member 133.

In other words, the stator 130 including the coil 132 generating electromagnetic force having a predetermined magnitude at the time of application of power and a plurality of cores 131 having the coil 132 wound therearound may be a fixed structure.

The core 131 may be fixedly disposed on the base member 133 including a printed circuit board (not shown) having pattern circuits printed thereon, the upper surface of base member 133 corresponding to the winding coil 330 may be provided with a plurality of coil holes having a predetermined size and penetrating through the base member 133 so as to expose the winding coil 132 downwardly, and the winding coil 132 may be electrically connected to the printed circuit board (not shown) so that external power is supplied thereto.

The outer peripheral surface of the sleeve 112 may be fixed to the base member 133 and the core 131 having the coil 132 wound therearound may be inserted into the base member 133. In addition, the base member 133 and the sleeve 112 may be assembled to each other by applying an adhesive to an inner surface of the base member 133 or the outer surface of the sleeve 112.

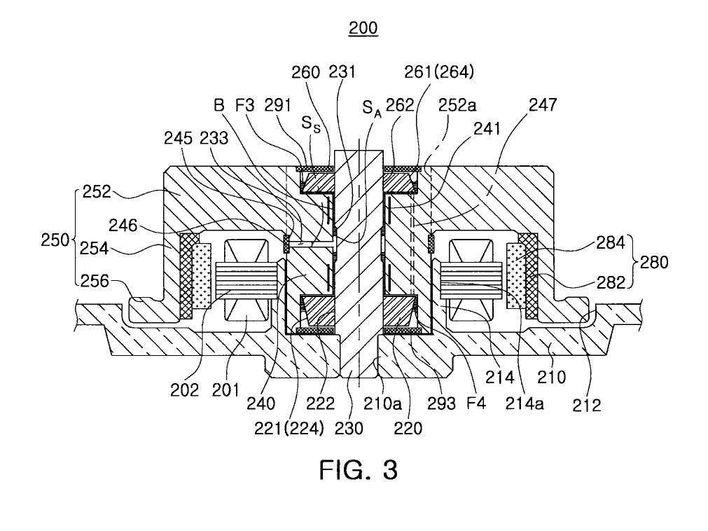

FIG. 3 is a schematic cross-sectional view illustrating a motor according to another embodiment of the present invention.

Referring to FIG. 3, the spindle motor 200 according to another embodiment of the present invention may include a base member 210, a lower thrust member 220, a shaft 230, a sleeve 240, a rotor hub 250, and an upper thrust member 260.

Here, a hydrodynamic bearing assembly may include the shaft 230, the sleeve 240, the upper and lower thrust members 220 and 260, and the rotor hub 250.

Here, terms with respect to directions will be defined. As viewed in FIG. 3, an axial direction refers to a vertical direction, that is, a direction from a lower portion of the shaft 230 toward an upper portion thereof or a direction from the upper portion of the shaft 230 toward the lower portion thereof, a radial direction refers to a horizontal direction, that is, a direction from the shaft 230 toward an outer peripheral surface of the rotor hub 250 or from the outer peripheral surface of the rotor hub 250 toward the shaft 230, and a circumferential direction refers to a rotation direction along a circumference of a circle having a radius spaced apart from the center of rotation by a predetermined distance.

Further, in the following description, rotating members may include the sleeve 240, the rotor hub 250, a magnet 280 mounted on the rotor hub 250, and the like, while fixed members, other than such rotating members, may be fixed, relative to the rotating members, and include the upper and lower thrust members 220 and 260, the base member 210, and the like.

The base member 210 may include a mounting groove 212 so as to form a predetermined space with the rotor hub 250. In addition, the base member 210 may include a coupling part 214 extended upwardly in the axial direction and having a stator core 202 installed on an outer peripheral surface thereof.

In addition, the coupling part 214 may include a seating surface 214a provided on the outer peripheral surface thereof so that the stator core 202 may be seated and installed thereon. Further, the stator core 202 seated on the coupling part 214 may be disposed above the mounting groove 212 of the base member 210.

The shaft 230 may be fixedly installed on the base member 210. That is, a lower end portion of the shaft 230 may be inserted into an installation hole 210a formed in the base member 210. In addition, the lower end portion of the shaft 230 may be bonded to an inner surface of the base member 210 by an adhesive and/or welding, so that the shaft 230 may be fixed thereto. Although the case in which the shaft is directly fixed to the base member is described in the embodiment of the present invention, the shaft may be indirectly fixed to the base member using a further member.

Meanwhile, the shaft 230 may be included, together with upper and lower thrust members 260 and 220 and the base member 210, in the fixed member, that is, the stator.

An upper surface of the shaft 230 may be provided with a coupling unit, for example, a screw part 134 having a screw fixed thereto, so that a cover member (not shown) may be fixedly installed.

The sleeve 240 may be rotatably installed on the shaft 230. To this end, the sleeve 240 may include a shaft support part provided as a through hole 241, into which the shaft 230 is inserted. Meanwhile, in the case in which the sleeve 240 is installed on the shaft 230, an inner peripheral surface of the sleeve 240 and an outer peripheral surface of the shaft 230 may be spaced apart from each other by a predetermined interval to form a bearing clearance B therebetween. In addition, this bearing clearance B may be filled with a lubricating fluid such as oil.

Further, the sleeve 240 may include upper and lower groove parts in which the upper and lower thrust members 260 and 220 are received. The upper and lower groove parts may be formed of a groove part bottom surface and a groove sidewall, respectively. In the present embodiment, ‘groove bottom surface’ refers to a surface of the groove part formed perpendicularly to the axial direction, and ‘groove sidewall’ refers to surfaces of the groove part formed in the axial direction.

In addition, the sleeve 240 may include radial dynamic pressure grooves 241 formed in an inner surface thereof in order to generate fluid dynamic pressure in the lubricating fluid provided in the bearing clearance B at the time of rotation thereof. That is, the radial dynamic pressure grooves 241 may be formed in upper and lower portions of the sleeve as shown in FIG. 3.

However, the radial dynamic pressure grooves are not limited to being formed in the inner surface of the sleeve 240, but may also be formed in the outer peripheral surface of the shaft 230 and have various shapes such as a herringbone shape, a spiral shape, a helical shape, or the like.

In addition, the sleeve 240 may further include a circulation hole 247 allowing the upper and lower groove parts thereof to be in communication with each other. The circulation hole 247 may discharge air bubbles contained in the lubricating fluid of the bearing clearance B to the outside and facilitate circulation of the lubricating fluid.

Meanwhile, the sleeve 240 may include a communication hole 233 allowing the bearing clearance B to be in communication with the outside. The sleeve 230 includes the communication hole 233 to enable a central portion of the bearing clearance B formed between the shaft 230 and the sleeve 240 to be in communication with the outside, whereby the air bubbles that may be generated in the oil provided in the bearing clearance B may be easily discharged.

Further, since the oil may be additionally provided in the communication hole 233, a total amount of oil provided in the bearing clearance B may be further secured.

Here, when the oil is provided in the communication hole 233, in the case in which the motor is not operated, an oil interface S_{S} may be additionally formed in the communication hole 233; however, in the case in which the motor is operated, the oil in the communication hole 233 is sucked into the bearing clearance B, such that oil interfaces S_{A} may be formed in upper and lower portions of the bearing clearance B between the shaft 230 and the sleeve 240, as shown in FIG. 3.

Meanwhile, according to the related art, there is a problem that the oil may be leaked through the communication hole. Therefore, according to the embodiment of the present invention, the communication hole 233 may be sealed by a gas-liquid separating unit 246 allowing gas to pass therethrough and blocking liquid, so that the air bubbles may be easily discharged, but the oil may not be leaked.

Here, the gas-liquid separating unit 246 may be formed of metal foam allowing gas to pass therethrough and blocking liquid. The metal foam may be a porous metal having a large number of air bubbles suspended in a foamed metal.

Further, the gas-liquid separating unit 246 may be formed of a gas-liquid separating film allowing gas to pass therethrough and blocking liquid. The gas-liquid separating film, having porosity, may be formed of various materials such as porous polytetrafluoroethylene, or the like.

Meanwhile, at least one of the inner peripheral surface of the sleeve 240 and the outer peripheral surface of the shaft 230 may be provided with a groove-shaped reservoir part 231 so that the bearing clearance B is wider in the reservoir part as compared with other portions thereof, and the communication hole 233 may be in communication with the reservoir part 231.

In addition, the gas-liquid separating unit 246 may have a ring shape so as to enclose an outer circumference of the sleeve 240 in the circumferential direction, and the sleeve 240 may include a seating groove 245 formed in the outer peripheral surface thereof and having a ring shape corresponding to that of the gas-liquid separating unit 246 to allow the gas-liquid separating unit 246 to be seated thereon.

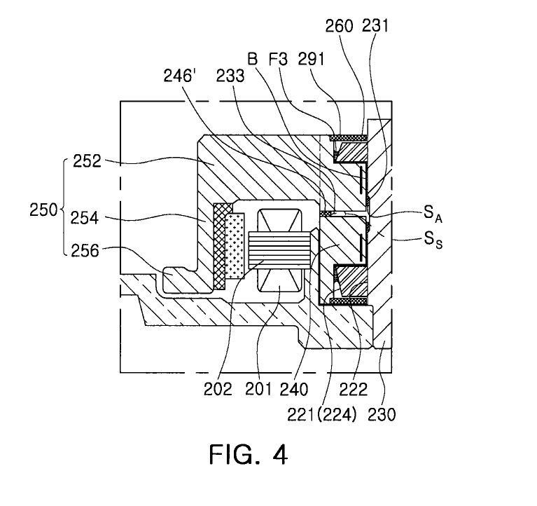

Meanwhile, with regard to the gas-liquid separating unit in the motor according to another embodiment of the present invention, a gas-liquid separating unit 246′ (See FIG. 4) may be provided to be fixed in a state in which it is inserted into the communication hole 233.

The rotor hub 250 may be coupled to the sleeve 240 to rotate together therewith.

The rotor hub 250 may include a rotor hub body 252 provided with an insertion part 252a in which the sleeve 240 is insertedly disposed, a mounting part 254 extended from an edge of the rotor hub body 252 and including a magnet assembly 280 mounted on an inner surface thereof, and an extension part 256 extended from an edge of the mounting part 254 in the outer radial direction.

Meanwhile, an inner surface of the rotor hub body 252 may be bonded to the outer surface of the sleeve 240. That is, the inner surface of the rotor hub body 252 may be bonded to a bonding surface 245 of the sleeve 240 by an adhesive and/or welding. In addition, the rotor hub body 252 may also be press-fitted into the sleeve 240.

Therefore, the sleeve 240 may rotate together with the rotor hub 250 at the time of rotation of the rotor hub 250.

In addition, the mounting part 254 may be extended from the rotor hub body 252 downwardly in the axial direction. Further, the mounting part 254 may include the magnet assembly 280 fixedly installed on the inner surface thereof.

Meanwhile, the magnet assembly 280 may include a yoke 282 fixedly installed on the inner surface of the mounting part 254 and a magnet 284 installed on an inner peripheral surface of the yoke 282.

The yoke 282 may serve to direct a magnetic field from the magnet 284 toward the stator core 202 to increase magnetic flux density. Meanwhile, the yoke 282 may have a circular ring shape or have a shape in which one edge portion thereof is bent so as to increase the magnetic flux density of the magnetic field generated from the magnet 284.

The magnet 284 may have an annular ring shape and be a permanent magnet generating a magnetic field having a predetermined magnitude by alternately magnetizing an N pole and an S pole in the circumferential direction.

Meanwhile, the magnet 284 may be disposed to face a front end of the stator core 202 having a coil 201 wound therearound and generate driving force capable of rotating the rotor hub 250 by electromagnetic interaction with the stator core 202 having the coil 201 wound therearound.

That is, when power is supplied to the coil 201, driving force capable of rotating the rotor hub 250 is generated by electromagnetic interaction between the stator core 202 having the coil 201 wound therearound and the magnet 284 disposed to face the stator core 202, such that the rotor hub 250 may rotate together with the sleeve 240.

The upper thrust member 260 may be fixed to an upper end portion of the shaft 230 and form an upper liquid-vapor interface F3 together with an upper groove sidewall of the sleeve 240. The upper thrust member 260 may include an inner surface 262 bonded to the shaft 230 and an outer surface 264 provided outwardly in the radial direction to form a liquid-vapor interface together with the upper groove sidewall. Here, the outer surface 264 may be provided as an upper inclined part 261 having an outer diameter smaller on an upper portion thereof than on a lower portion thereof.

Meanwhile, thrust dynamic pressure grooves for generating thrust dynamic pressure may be formed in at least one of a lower surface of the upper thrust member 260 and the upper groove bottom surface of the sleeve 240 disposed to face the lower surface of the upper thrust member 260. According to the embodiment of the present invention, in the case in which the circulation hole 247 is not formed in the sleeve 240, the thrust dynamic pressure groove may include all types of thrust dynamic pressure grooves formed in the radial direction. For example, one or two or more thrust dynamic pressure grooves may be formed in the radial direction. Meanwhile, according to the embodiment of the present invention, in the case in which the circulation hole 247 is formed in the sleeve 240, the thrust dynamic pressure groove is only formed inwardly of the circulation hole 247 in the radial direction.

In addition, an upper cap 291 may be provided above the upper thrust member 260 as a sealing member preventing the lubricating fluid provided in the bearing clearance B from being leaked upwardly. The upper cap 291 may serve to cover the upper groove part in the axial direction to prevent the lubricating fluid from being scattered and leaked through the upper groove part. That is, the upper cap 291 may be fixed to the upper groove sidewall of the sleeve 240 by a press-fitting or an adhesive adhering method, and a clearance between the shaft 230 and a shaft hole of the upper cap 291 allowing the shaft 230 to protrude upwardly of the upper cap 291 may be narrow to suppress air containing evaporated lubricating fluid from being leaked to the outside, whereby a reduction in the lubricating fluid provided in the bearing clearance B may be suppressed.

The lower thrust member 220 may be fixedly installed on a lower end portion of the shaft 230 and form a lower liquid-vapor interface F4 together with the lower groove sidewall of the sleeve 240. The lower thrust member 220 may include an inner surface 222 bonded to the shaft 230 and an outer surface 224 provided outwardly in the radial direction and forming a liquid-vapor interface together with the lower groove sidewall. Here, the outer surface 224 may be provided as a lower inclined part 221 having an outer diameter smaller on an upper portion thereof than on a lower portion thereof.

Meanwhile, thrust dynamic pressure grooves for generating thrust dynamic pressure may be formed in at least one of an upper surface of the lower thrust member 220 and the lower groove bottom surface of the sleeve 240 disposed to face the upper surface of the lower thrust member 220. According to the embodiment of the present invention, in the case in which the circulation hole 247 is not formed in the sleeve 240, the thrust dynamic pressure groove may include all types of thrust dynamic pressure grooves formed in the radial direction. For example, one or two or more of the thrust dynamic pressure grooves may be formed in the radial direction. Meanwhile, according to the embodiment of the present invention, in the case in which the circulation hole 247 is formed in the sleeve 240, the thrust dynamic pressure groove is only formed inwardly of the circulation hole 247 in the radial direction.

In addition, a lower cap 293 may be provided below the lower thrust member 220 with as a sealing member preventing the lubricating fluid provided in the bearing clearance B from being leaked downwardly. The lower cap 293 may serve to cover the lower groove part in the axial direction to prevent the lubricating fluid from being scattered and leaked through the lower groove part. That is, the lower cap 293 may be fixed to the lower groove sidewall of the sleeve 240 by a press-fitting method or an adhesive adhering method, and a clearance between the shaft 230 and a shaft hole of the lower cap 293 allowing the shaft 230 to protrude downwardly of the lower cap 293 may be narrow to suppress air containing evaporated lubricating fluid from being leaked to the outside, whereby a reduction in the lubricating fluid provided in the bearing clearance B may be suppressed.

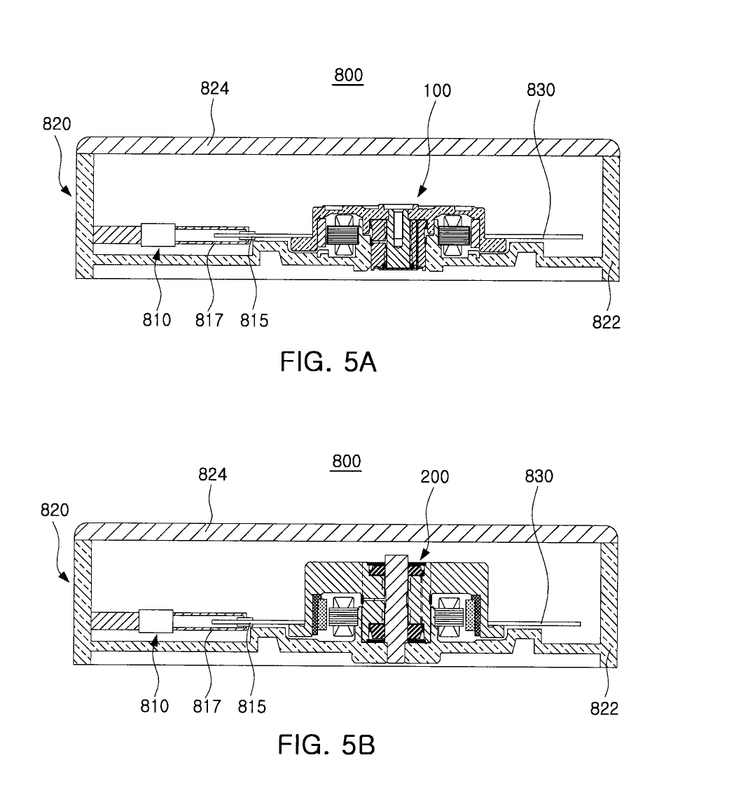

Referring to FIGS. 5A and 5B, a recording disk driving device 800 having the motor 100 or 200 according to the embodiment of the present invention mounted therein may be a hard disk drive, and may include the motor 100 or 200, a head transfer part 810, and a housing 820.

The motor 100 or 200 may have all the characteristics of the motor according to the above-described embodiments of the present invention and have a recording disk 830 mounted thereon.

The head transfer part 810 may transfer a read/write head 815 detecting information of the recording disk 830 mounted on the motor 100 or 200 to a surface of the recording disk from which the information is to be detected.

Here, the read/write head 815 may be disposed on a support part 817 of the read/write head transfer part 810.

The housing 820 may include a motor mounting plate 822 and a top cover 824 shielding an upper part of the motor mounting plate 822, in order to form an internal space receiving the motor 100 or 200 and the read/write head transfer part 810 therein.

As set forth above, a motor according to embodiments of the present invention can prevent the leakage of a fluid in spite of using a hydrodynamic bearing structure including a communication hole.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a shaft; and
a sleeve having the shaft rotatably provided therein, having a bearing clearance formed between the shaft and the sleeve and filled with oil, and including a communication hole allowing the bearing clearance to be in communication with the outside,
wherein the communication hole is sealed by a gas-liquid separating unit allowing gas to pass therethrough and blocking liquid.

2. A hydrodynamic bearing assembly comprising:
a shaft fixedly installed directly or indirectly on a base member; and
a sleeve rotatably installed on the shaft, having a bearing clearance formed between the shaft and the sleeve and filled with oil, and including a communication hole allowing the bearing clearance to be in communication with the outside,
wherein the communication hole is sealed by a gas-liquid separating unit allowing gas to pass therethrough and blocking liquid.

3. The hydrodynamic bearing assembly of claim 1, wherein the gas-liquid separating unit is formed of metal foam allowing gas to pass therethrough and blocking liquid.

4. The hydrodynamic bearing assembly of claim 2, wherein the gas-liquid separating unit is formed of metal foam allowing gas to pass therethrough and blocking liquid.

5. The hydrodynamic bearing assembly of claim 1, wherein the gas-liquid separating unit is formed of a gas-liquid separating film allowing gas to pass therethrough and blocking liquid.

6. The hydrodynamic bearing assembly of claim 2, wherein the gas-liquid separating unit is formed of a gas-liquid separating film allowing gas to pass therethrough and blocking liquid.

7. The hydrodynamic bearing assembly of claim 1, wherein at least one of an inner peripheral surface of the sleeve and an outer peripheral surface of the shaft is provided with a groove-shaped reservoir part so that the bearing clearance is wider in the reservoir part as compared with other portions thereof, and
the communication hole is in communication with the reservoir part.

8. The hydrodynamic bearing assembly of claim 2, wherein at least one of an inner peripheral surface of the sleeve and an outer peripheral surface of the shaft is provided with a groove-shaped reservoir part so that the bearing clearance is wider in the reservoir part as compared with other portions thereof, and
the communication hole is in communication with the reservoir part.

9. The hydrodynamic bearing assembly of claim 1, wherein the gas-liquid separating unit is formed to have a ring shape so as to enclose an outer circumference of the sleeve in a circumferential direction.

10. The hydrodynamic bearing assembly of claim 2, wherein the gas-liquid separating unit is formed to have a ring shape so as to enclose an outer circumference of the sleeve in a circumferential direction.

11. The hydrodynamic bearing assembly of claim 9, wherein the sleeve includes a seating groove formed in an outer peripheral surface thereof and having a ring shape corresponding to that of the gas-liquid separating unit to allow the gas-liquid separating unit to be seated thereon.

12. The hydrodynamic bearing assembly of claim 10, wherein the sleeve includes a seating groove formed in an outer peripheral surface thereof and having a ring shape corresponding to that of the gas-liquid separating unit to allow the gas-liquid separating unit to be seated thereon.

13. The hydrodynamic bearing assembly of claim 1, wherein the gas-liquid separating unit is inserted into the communication hole.

14. A spindle motor comprising:
a hydrodynamic bearing assembly including a shaft, and a sleeve having the shaft provided therein, having a bearing clearance formed between the shaft and the sleeve and filled with oil, and including a communication hole allowing the bearing clearance to be in communication with the outside, the communication hole being sealed by a gas-liquid separating unit allowing gas to pass therethrough and blocking liquid;
a stator coupled to the outside of the sleeve and a core having a coil wound therearound in order to generate rotational driving force; and
a hub mounted to be rotatable with respect to the stator and having a magnet mounted on one surface thereof, the magnet facing the coil.
